(19) United States
(12) Patent Application Publication
(10) Pub. No.: US 2023/0295054 A1
(43) Pub. Date: Sep. 21, 2023

(54) FERTILIZER COMPOSITION CONTAINING CARBOHYDRATE AND PHOSPHORUS, PREPARATION METHOD AND USE THEREOF

(71) Applicant: CHINA AGRICULTURAL UNIVERSITY, Haidian District Beijing (CN)

(72) Inventor: Gu Feng, Haidian District Beijing (CN)

(21) Appl. No.: 18/041,468

(22) PCT Filed: Oct. 15, 2021
(86) PCT No.: PCT/CN2021/124038

§ 371 Date: Feb. 13, 2023

(30) Foreign Application Priority Data
Oct. 15, 2020 (CN) 202011102074.8

(51) Int. Cl. C05B 7/00; C05G 3/00

(52) U.S. Cl. CPC C05B 7/00; C05G 3/00

(57) ABSTRACT

Disclosed are a fertilizer composition containing a carbohydrate and phosphorus and a preparation method and use thereof, which belong to the technical field of agriculture. The fertilizer composition has a mass ratio of carbon to phosphorus of 1-15:1, and is divided into a low-carbon fertilizer composition (with a carbon-to-phosphorus ratio of 1-4:1) and a high-carbon fertilizer composition (with a carbon-to-phosphorus ratio of 4-15:1).

### CROSS REFERENCE TO RELATED APPLICATION

This application claims the benefit and priority of Chinese Patent Application No. 202011102074.8, entitled “Fertilizer composition containing carbohydrate and phosphorus, preparation method and use thereof” filed on Oct. 15, 2020, the disclosure of which is incorporated by reference herein in its entirety as part of the present application.

### TECHNICAL FIELD

The present disclosure belongs to the field of agriculture and relates to a fertilizer composition containing a carbohydrate and phosphorus, a preparation method and use thereof.

### BACKGROUND ART

During the mobilization and utilization of phosphorus in the soil, microorganisms play the following two important roles: first, the phosphorus fertilizer applied to soil is quickly absorbed by soil microorganisms and subsequently accumulated within the soil microbial biomass to form microbial biomass phosphorus; second, the microbial biomass phosphorus turnover process happens during the microbes are growth or dead, and the phosphorus in microbial tissue is released into soil available phosphorus pool. Phosphatase secreted by phosphate-solubilizing microorganisms can hydrolyze organic phosphorus into orthophosphate for plant uptake and utilization. Organic acid anions secreted by microorganisms could chelate metal cations combined with phosphate radicals. Protons secreted by microorganisms and CO₂ released through respiration could also reduce rhizosphere soil pH, thereby promoting the dissolution of poorly soluble phosphates (Meyer et al. 2019). However, for the growth of soil microorganisms, the majority of microorganisms in cropland soil are in a state of “carbon starvation”, and only about 5% are in an active state. Therefore, targeted activation of soil phosphate solubilizing microbes by the addition of suitable carbohydrates has become a hot but difficult issue in fertilizer innovation with which we can promote the metabolic activity of soil phosphate mobilizing microorganisms, strengthen the mobilization of soil phosphates and the turnover of microbial biomass phosphorus, reduce the loss of phosphorus fertilizers availability after being applied to soil, and improve the phosphorus fertilizers use efficiency by crops.

A carbon-to-phosphorus ratio plays a crucial role in regulating the phosphorus mobilization and turnover process by soil microorganisms. Under the carbon-limited condition, increasing the soil carbon-to-phosphorus ratio could promote organic phosphorus mineralization by soil microorganisms, and improve the activity of alkaline phosphatase, and the abundance and diversity of bacterial functional groups containing phoD gene. Furthermore, increasing the carbon-to-phosphorus ratio could also increase the soil respiration rate and promote the acidification of the micro-regional of the local soil. However, excessive carbon input will lead to a large amount of phosphate fertilizer being fixed by microorganisms, resulting in the decrease of available phosphorus content in soil and inhibition of crop growth. Therefore, an appropriate carbon-to-phosphorus ratio is critical to regulate the phosphorus mobilizing function of microorganisms and improve phosphorus use efficiency. However, up to now, there is no specific technical parameter about the stoichiometric carbon-to-phosphorus ratio relating to carbohydrates to phosphates in fertilizer products.

### SUMMARY

To solve the above problems, the present disclosure provides a fertilizer composition containing a carbohydrate and phosphorus, and a preparation method and use thereof. The fertilizer composition could improve the phosphate fertilizer use efficiency and regulate the activity of indigenous microorganisms.

The present disclosure provides a fertilizer composition, comprising a carbohydrate and a phosphorus-containing compound,

wherein a mass ratio of carbon in the carbohydrate to phosphorus in the phosphorus-containing compound is in a range of 1-15:1, and

the carbohydrate is at least one selected from the group consisting of citric acid, starch, L-arabinose, galactose, chitosan, erythrose, fructose, maltose and lactose.

In the above fertilizer composition, the phosphorus-containing compound is at least one selected from the group consisting of monoammonium phosphate, diammonium phosphate, potassium dihydrogen phosphate, urea phosphate, ammonium polyphosphate and phosphoric acid.

In some embodiments, the ammonium polyphosphate has a polymerization degree of 2-10, and could be purchased from Yunnan Tianyao Chemical Co., Ltd, China.

In some embodiments, the fertilizer composition further comprises water; and a mass ratio of water to the carbohydrate is in a range of (1-3):10.

In some embodiments, the fertilizer composition may be a low-carbon fertilizer composition or a high-carbon fertilizer composition,
wherein, under the condition of being the low-carbon fertilizer composition, the mass ratio of carbon in the carbohydrate to phosphorus in the phosphorus-containing compound is in a range of 1-4:1, specifically, may be 2.45-3.66:1, and
under the condition of being the high-carbon fertilizer composition, the mass ratio of carbon in the carbohydrate to phosphorus in the phosphorus-containing compound is in a range of 4-15:1, specifically, may be 5.5:1.

The present disclosure further provides a method for fertilization, comprising applying a fertilizer, wherein the fertilizer is the fertilizer composition as described above.

In the above method for fertilization, the fertilizer is applied in an amount of 125-445 kg per hectare of cropland, specifically 203.0 kg or 362.5 kg;
the fertilizer is applied to maize or cotton;
the fertilizer is applied 1 to 3 times; and
the fertilizer is applied by fertigation, banding fertilization or hole fertilization.

When the fertilizer is applied to maize (such as spring maize) by banding fertilization, the fertilizer is applied twice,
wherein, the first and second fertilization time and fertilizer application rates are as follows:
when maize is sown, 40% of a total amount of the fertilizer composition is applied together with seed fertilizer, and
when the fertilizer is topdressed at the maize jointing stage, 60% of the total amount of the fertilizer composition is applied.

When the fertilizer is applied to maize (such as spring maize) through fertigation, the fertilizer is applied 3 times,
wherein, the first, second and third fertilization application times and fertilizer application rates are as follows:
when maize is drip-irrigated with emergency water after sown, the fertilizer is applied for the first time with 40% of the total amount of the fertilizer composition;
when maize is drip-irrigated with the first water after the seedling emergency, the fertilizer is applied for the second time with 40% of the total amount of the fertilizer composition; and
when maize is drip-irrigated with the third water after the seedling emergency, the fertilizer is applied for the third time with 20% of the total amount of the fertilizer composition.

The present disclosure further provides use of the fertilizer composition as described above in any one of the following a to d:
a: improving the utilization efficiency of a phosphate fertilizer;
b: enhancing the activity of indigenous soil phosphorus-solubilizing microorganisms;
c: promoting the growth of a crop; and
d: increasing phosphorus availability in soil.

Furthermore, the present disclosure provides a method for preparing the fertilizer composition as described above, comprising
uniformly mixing each component according to a ratio of carbon to phosphorus to obtain the fertilizer composition.

In some embodiments, the method for preparing the fertilizer composition provided by the present disclosure comprises steps of:
according to the ratio of carbon to phosphorus, uniformly mixing the carbohydrate and the phosphorus-containing compound to obtain a mixture, and making the mixture into a form of powder to obtain a powder fertilizer composition; or
according to the ratio of carbon to phosphorus, dissolving the carbohydrate in water to obtain a carbohydrate solution, dissolving the phosphorus-containing compound, and adding the dissolved phosphorus-containing compound into the carbohydrate solution to obtain a liquid fertilizer composition.

The present disclosure has the following beneficial effects: The present disclosure provides a fertilizer composition with a specific ratio of carbon to phosphorus. Since the composition contains a carbon source that stimulates the growth and activity of microorganisms, after the fertilizer composition is applied to soil, compared with a similar product in the prior art, it could significantly improve the activity of indigenous phosphorus-solubilizing microorganisms, and could simultaneously improve the soil phosphorus availability, so as to achieve the purpose of accelerating the growth of crop and improving the utilization efficiency of phosphorus fertilizer. The inventors of the present disclosure found that when a mixture of a chemical phosphorus fertilizer and a carbon-containing compound (with a ratio of carbon to phosphorus of 1-13.3:1) is applied, the activity of soil microorganisms and phosphatase is significantly increased, and the growth of crops and the absorption efficiency of phosphorus are significantly improved. When the chemical phosphorus fertilizer containing 19.6-32.7 kg of phosphorus and the carbon-containing compound containing 48-120 kg of carbon is applied to each hectare of cropland, soil respiration is enhanced, and soil phosphatase activity and water-soluble phosphorus content are increased, and crop yield is significantly improved.

### BRIEF DESCRIPTION OF THE DRAWINGS

FIG. 1A to FIG. 1D show the effects of applying a fertilizer composition containing a carbohydrate and phosphorus on maize yield, partial factor productivity of phosphorus fertilizer, water-soluble phosphorus concentration and soil respiration rate, in which FIG. 1A shows maize yields in different treatments, FIG. 1B shows partial factor productivity of phosphorus fertilizer in different treatments, FIG. 1C shows water-soluble phosphorus concentrations in different treatments, FIG. 1D shows soil respiration rates in different treatments; and different lowercase letters indicates that the significant difference across the different treatments (P≤0.05).

FIG. 2A to FIG. 2C show the effects of applying the fertilizer composition containing a carbohydrate and phosphorus on maize yield, soil alkaline phosphatase activity and partial factor productivity of phosphorus fertilizer, in which FIG. 2A shows maize yields in different treatments, FIG. 2B shows soil alkaline phosphatase activity in different treatments, FIG. 2C shows partial factor productivity of phosphorus fertilizer in different treatments; and different lowercase letters indicates that the significant difference across the different treatments (P≤0.05).

### DETAILED DESCRIPTION OF THE EMBODIMENTS

The present disclosure is described more clearly and completely in conjunction with specific embodiments below. It will be apparent that the protection scope of the present disclosure is not limited to the scope described by the embodiments. Any other various forms of products obtained by anyone under the inspiration of the present disclosure, which has the same technical solutions as the present disclosure, regardless of changes in the carbon-containing compound, chemical phosphate fertilizer raw material type or component ratio, shall fall within the protection scope of the present disclosure. The methods are conventional unless otherwise specified. The raw materials could be available from open commercial sources unless otherwise specified.

### Example 1 Applying a Fertilizer Composition Containing a Carbohydrate and Phosphorus to Spring Maize by Banding Fertilization

1. The composition and the carbon-to-phosphorus ratio of the fertilizer composition containing a carbohydrate and phosphorus in this example were as follows:
   novel fertilizer composition 1 (low-carbon type): a carbon-to-phosphorus ratio of 2.45:1, 128 parts of citric acid (containing 37.5% of carbon, equivalent to 48 parts of carbon) and 75 parts of monoammonium phosphate (containing 60% of P₂O₅, equivalent to 19.6 parts of phosphorus);
   novel fertilizer composition 2 (high-carbon type): a ratio of carbon-to-phosphorus of 5.5:1, 287.5 parts of citric acid (containing 37.5% of carbon, equivalent to 107.8 parts of carbon) and 75 parts of monoammonium phosphate (containing 60% of P₂O₅, equivalent to 19.6 parts of phosphorus).
2. Methods for preparation and use of a fertilizer composition were as follows: The above specific amount of citric acid and monoammonium phosphate were uniformly mixed, and made into a form of powder, obtaining a powder fertilizer composition. A trench with a depth of 7-15 cm was furrowed near the crop root, the powder fertilizer composition was applied evenly in the trench, and covered with soil, and irrigated in time.
3. Take the seed of spring maize with a target yield of 10.5 t ha⁻¹ as an example.

The method for applying the novel fertilizer composition containing a carbohydrate and phosphorus involves the type of the novel fertilizer composition, the total amount of the fertilizer applied in the whole growth stage and the amount of the fertilizer applied in different growth stages.
(1) The above novel fertilizer composition 1 (low-carbon type) was applied to soil in twice with a total amount of 203.0 kg ha⁻¹ per hectare of cropland (equivalent to a total amount of carbon and phosphorus of 67.6 kg ha⁻¹, containing 19.6 kg P ha⁻¹).

When maize was sown, 40% of the total amount of the fertilizer composition was applied (the amount of the fertilizer composition was 81.2 kg ha⁻¹, which was equivalent to a total amount of carbon and phosphorus of 27.0 kg ha⁻¹).

During the maize jointing stage, 60% of the total amount of the fertilizer composition was applied (the amount of the fertilizer composition was 121.8 kg ha⁻¹, which was equivalent to a total amount of carbon and phosphorus of 40.6 kg ha⁻¹).
(2) The above novel fertilizer composition 2 (high-carbon type) was applied to soil in twice with a total amount of 362.5 kg ha⁻¹ per hectare of cropland (equivalent to a total amount of carbon and phosphorus of 127.4 kg ha⁻¹, containing 19.6 kg P ha⁻¹).

When maize was sown, 40% of the total amount of the fertilizer composition was applied (the amount of the fertilizer composition was 145.0 kg ha⁻¹, which was equivalent to a total amount of carbon and phosphorus of 51.0 kg ha⁻¹).

During the maize jointing stage, 60% of the total amount of the fertilizer composition was applied (the amount of the fertilizer composition was 217.5 kg ha⁻¹, which was equivalent to a total amount of carbon and phosphorus of 76.4 kg ha⁻¹).

Other fertilizer applications and farming practices were consistent with those in actual production.

Use Effect:

A field experiment was conducted at the Shangzhuang Experimental Station of China Agricultural University according to the above method, and 4 treatments were set up.
Treatment 1: as a control, no phosphate fertilizer was applied, other fertilizers were provided in sufficient quantities according to the production routine;
Treatment 2: phosphate fertilizer was applied in an amount of 52.4 kg P ha⁻¹ (120 kg P₂O₅ ha⁻¹);
Treatment 3:203.0 kg ha⁻¹ of the novel fertilizer composition 1 (low-carbon type) was applied; and
Treatment 4:362.5 kg ha⁻¹ of the novel fertilizer composition 2 (high-carbon type) was applied.

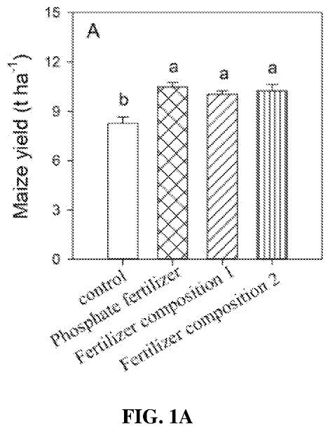

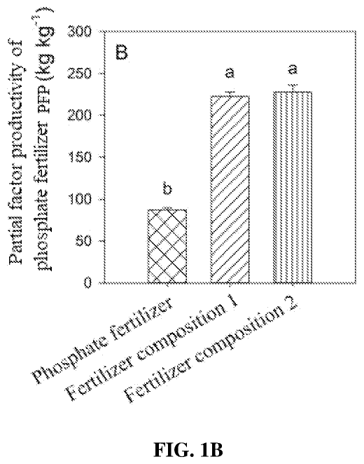

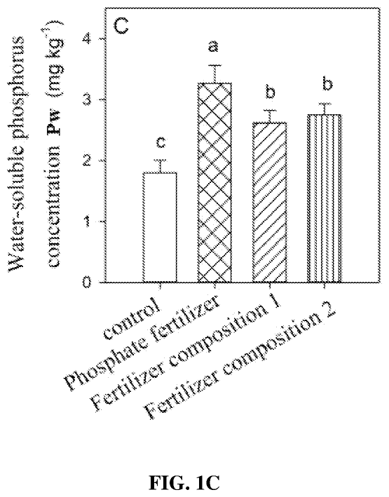

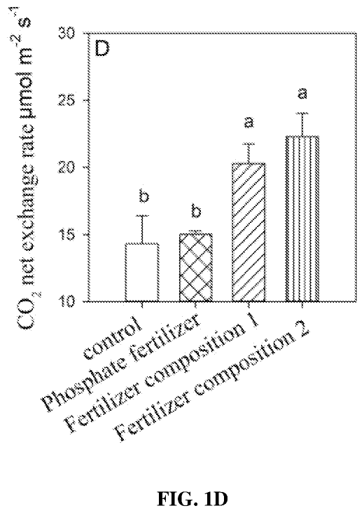

The results are shown in FIGS. 1A to 1D. Compared with the control treatment, the yield is increased by 21.4% and 24.2% by applying the novel fertilizer compositions 1 and 2, respectively (see FIG. 1A). Compared with the application of phosphate fertilizer, the partial factor productivity of phosphate fertilizer treated by the application of the novel fertilizer composition is increased by 158%, wherein the partial factor productivity of phosphate fertilizer treated by the application of the novel fertilizer compositions 1 and 2 is increased by 155% and 161%, respectively (see FIG. 1 B). After the application of the novel fertilizer composition, the average content of soil water-soluble phosphorus is increased by 49.2% compared with the control without phosphorus application, wherein, compared with the control, the soil water-soluble phosphorus treated by the application of the novel fertilizer compositions 1 and 2 is increased by 45.0% and 52.3%, respectively (see FIG. 1 C). In addition, the soil respiration treated with the novel fertilizer composition is increased by 48.7% compared with the control without phosphate fertilizer, and increased by 41.7% compared with the phosphate fertilizer treatment (see FIG. 1 D). It is indicated that in agricultural production, the fertilizer provided in the present disclosure could strongly regulate the activity of microorganisms, increase the content of soil water-soluble phosphorus, and improve the phosphate fertilizer use efficiency.

### Example 2 Applying a Fertilizer Composition Containing a Carbohydrate and Phosphorus to Spring Maize by Fertigation

1. The composition and the carbon-to-phosphorus ratio of the fertilizer composition containing a carbohydrate and phosphorus in this example were as follows:
novel fertilizer composition 1 (citric acid):
a carbon-to-phosphorus ratio of 3.66:1, 320 parts of citric acid (containing 37.5% of carbon, equivalent to 120 parts of carbon), 125 parts of monoammonium phosphate (containing 60% of P₂O₅, equivalent to 32.7 parts of phosphorus);
novel fertilizer composition 2 (fructose):
a carbon-to-phosphorus ratio of 3.66:1, 300 parts of fructose (containing 40% carbon, equivalent to 120 parts of carbon), 125 parts of monoammonium phosphate (containing 60% of P₂O₅, equivalent to 32.7 parts of phosphorus).
2. Methods for preparation and use are as follows: When dripping water, the above parts of citric acid, fructose and monoammonium phosphate were weighed, and mixed uniformly according to the above proportion, obtaining a novel powder fertilizer composition containing a carbohydrate and phosphorus. The novel powder fertilizer composition was added into a fertilizer tank and stirred uniformly to obtain a mixture, and the mixture was applied by dripping fertilization.
3. Take spring maize with a target yield of 12 t ha⁻¹ as an example.

The method for applying a novel fertilizer composition involves the type of the novel fertilizer composition, the total amount of the fertilizer in the whole growth stage and the amount in different growth stages.
(1) The above novel fertilizer composition 1 (citric acid) was applied to soil in three times with a total amount of 445.0 kg ha⁻¹ per hectare of cropland (equivalent to a total amount of carbon and phosphorus of 152.7 kg ha⁻¹, containing 32.7 kg P ha⁻¹ of phosphorus).

When maize was drip-irrigated with emergency water after sown, the fertilizer composition was applied for the first time in an amount that accounts for 40% of the total amount of the fertilizer composition (the amount of the novel fertilizer composition was 178.0 kg ha⁻¹, which was equivalent to a total amount of carbon and phosphorus of 61.1 kg ha⁻¹);

When maize was drip-irrigated with the first water after the seedling emergency, the fertilizer composition was applied for the second time in an amount that accounts for 40% of the total amount of the fertilizer composition (the amount of the novel fertilizer composition was 178.0 kg ha⁻¹, which was equivalent to a total amount of carbon and phosphorus of 61.1 kg ha⁻¹); and

When maize was drip-irrigated with the third water after the seedling emergency, the fertilizer composition was applied for the third time in an amount that accounts for 20% of the total amount of the fertilizer composition (the amount of the novel fertilizer composition was 89.0 kg ha⁻¹, which is equivalent to a total amount of carbon and phosphorus of 30.5 kg ha⁻¹).
(2) The above novel fertilizer composition 2 (fructose) was applied to soil in three times with a total amount of 425.0 kg ha⁻¹ per hectare of cropland (equivalent to a total amount of carbon and phosphorus of 152.7 kg ha⁻¹, containing 32.7 kg P ha⁻¹ of phosphorus).

When maize was drip-irrigated with emergency water after sown, the fertilizer composition was applied for the first time in an amount that accounts for 40% of the total amount of the fertilizer composition (the amount of the novel fertilizer composition was 170.0 kg ha⁻¹, which is equivalent to a total amount of carbon and phosphorus of 61.1 kg ha⁻¹);

When maize was drip-irrigated with the first water after the seedling emergency, the fertilizer composition was applied for the second time in an amount that accounts for 40% of the total amount of the fertilizer composition (the amount of the novel fertilizer composition was 170.0 kg ha⁻¹, which is equivalent to a total amount of carbon and phosphorus of 61.1 kg ha⁻¹);

when maize was drip-irrigated with the third water after the seedling emergency, the fertilizer composition was applied for the third time in an amount that accounts for 20% of the total amount of the fertilizer composition (the amount of the novel fertilizer composition was 85.0 kg ha⁻¹, which is equivalent to a total amount of carbon and phosphorus elements of 30.5 kg ha⁻¹).

Other fertilizer applications and farming practices were consistent with those in actual production.

Use Effect:

A field experiment was conducted in Shihezi, Xinjiang, China, according to the above method, and 4 treatments were set up.
Treatment 1: as a control, no phosphate fertilizer was applied, other fertilizers were provided in sufficient quantities according to the production routine;
Treatment 2: phosphate fertilizer was applied in an amount of 52.4 kg P ha⁻¹ (120 kg P₂O₅ ha⁻¹);
Treatment 3: the novel fertilizer composition 1 (critic acid) was applied in an amount of 445.0 kg ha⁻¹; and
Treatment 4: the novel fertilizer composition 2 (fructose) was applied in an amount of 425.0 kg ha⁻¹.

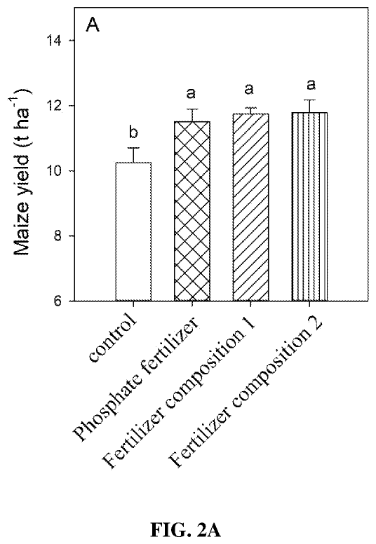

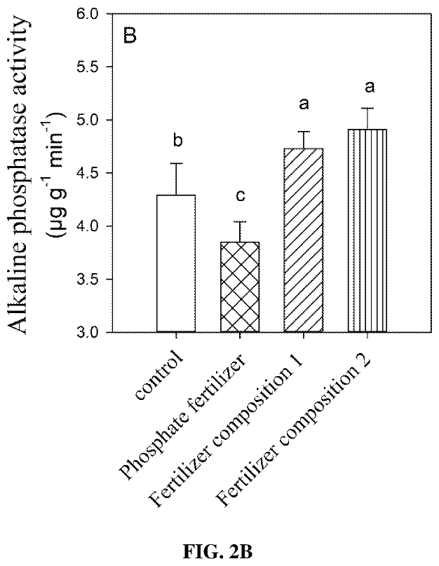

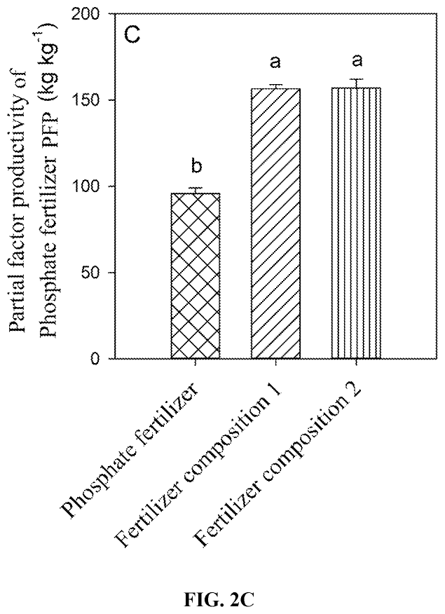

The results are shown in FIGS. 2A to 2C. Compared with the control treatment, the average yield is increased by 14.8% by applying the novel fertilizer compositions, wherein compared with the control treatment, the yield is increased by 14.6% by applying the novel fertilizer composition 1, and increased by 15.0% by applying the novel fertilizer composition 2 (see FIG. 2A). Compared with the treatment with phosphate fertilizer, under the condition that the novel fertilizer compositions are applied in an amount that is 37.6% less than that of phosphate fertilizer, the maize yield is not reduced, in which, the yield is increased by 2.1% for fertilizer composition 1 and increased by 2.4% for fertilizer composition 2 (see FIG. 2A). After the application of the novel fertilizer compositions, the average soil alkaline phosphatase activity is increased by 12.4% compared with the control without phosphorus application, and increased by 25.2% compared with the phosphate fertilizer. The alkaline phosphatase activity after applying fertilizer composition 1 is increased by 10.3% compared with the control and increased by 22.9% compared with the phosphate fertilizer. The alkaline phosphatase activity after applying fertilizer composition 2 is increased by 14.5% compared with the control, and increased by 27.5% compared with the phosphate fertilizer (see FIG. 2B). In addition, compared with the application of phosphate fertilizer, the partial factor productivity of phosphorus fertilizer treated by application of the novel fertilizer compositions is increased by 63.6%, wherein the partial factor productivity of phosphorus fertilizer treated by application of the novel fertilizer composition 1 and 2 is increased by 63.3% and 63.9%, respectively (see FIG. 2C). It is indicated that in agricultural production, the fertilizer provided in the present disclosure could strongly regulate the activity of phosphorus-solubilizing microorganisms, and improve the phosphate fertilizer use efficiency.

Although the above embodiments have made a detailed description of the present disclosure, they are only a part of the embodiments of the present disclosure, rather than all the embodiments. Other embodiments could also be obtained according to the present embodiments without creativity, and they shall fall within the protection scope of the present disclosure.

1. A fertilizer composition, comprising a carbohydrate and a phosphorus-containing compound, wherein a mass ratio of carbon in the carbohydrate to phosphorus in the phosphorus-containing compound is in a range of 1-15:1.

2. The fertilizer composition of claim 1, wherein the carbohydrate is at least one selected from the group consisting of citric acid, starch, L-arabinose, galactose, chitosan, erythrose, fructose, maltose and lactose.

3. The fertilizer composition of claim 1, wherein the phosphorus-containing compound is at least one selected from the group consisting of monoammonium phosphate, diammonium phosphate, potassium dihydrogen phosphate, urea phosphate, ammonium polyphosphate and phosphoric acid.

4. The fertilizer composition of claim 1, wherein the fertilizer composition further comprises water; and a mass ratio of water to the carbohydrate is in a range of 1-3:10.

5. (canceled)

6. (canceled)

7. (canceled)

8. A low-carbon fertilizer composition, comprising a carbohydrate and a phosphorus-containing compound, wherein a mass ratio of carbon in the carbohydrate to phosphorus in the phosphorus-containing compound is in a range of 1-4:1.

9. The low-carbon fertilizer composition of claim 8, wherein the mass ratio of carbon in the carbohydrate to phosphorus in the phosphorus-containing compound is in a range of 2.45-3.66:1.

10. A high-carbon fertilizer composition, comprising a carbohydrate and a phosphorus-containing compound, wherein a mass ratio of carbon in the carbohydrate to phosphorus in the phosphorus-containing compound is in a range of 4-15:1.

11. The high-carbon fertilizer composition of claim 10, wherein the mass ratio of carbon in the carbohydrate to phosphorus in the phosphorus-containing compound is 5.5:1.

12. (canceled)

13. (canceled)

14. (canceled)

15. (canceled)

16. (canceled)

17. The fertilizer composition of claim 2, wherein the fertilizer composition further comprises water; and a mass ratio of water to the carbohydrate is in a range of 1-3:10.

18. The fertilizer composition of claim 3, wherein the fertilizer composition further comprises water; and a mass ratio of water to the carbohydrate is in a range of 1-3:10.
